(19) United States
(12) Patent Application Publication
(10) Pub. No.: US 2010/0254008 A1
(43) Pub. Date: Oct. 7, 2010

(54) CEMENTED OPTICAL ELEMENT AND CEMENTING METHOD

(76) Inventor: Katsuhiko Ono, Sano-shi (JP)

Correspondence Address: BIRCH STEWART KOLASCH & BIRCH, PO BOX 747, FALLS CHURCH, VA, 22040-0747, US

(21) Appl. No.: 12/723,382

(22) Filed: Mar. 12, 2010

(30) Foreign Application Priority Data
Apr. 2, 2009 (JP) P2009-090051

(51) Int. Cl. G02B 1/11; G02C 7/00

(52) U.S. Cl. 359/580; 156/99

(57) ABSTRACT

A polarizing beam splitter (PBS) 14 includes a first prism 31, a second prism 32, a polarizing split film 29, an antireflection film 33, and an adhesive 34. The first and second prisms 31 and 32 are made of transparent materials and are cemented to each other by the adhesive having a refractive index less than those of the first and second prisms 31 and 32. The polarizing split film 29 is formed on a surface of the first prism 31. The antireflection film 33 is provided on one surface of the second prism 32 to which the first prism 31 is cemented. The antireflection film 33 has a refractive index distribution in which a refractive index decreases from the second prism 32 side to the adhesive 34 side and prevents reflection of light between the second prism 32 and the adhesive 34.

### CROSS-REFERENCE TO RELATED APPLICATIONS

This application is based upon and claims the benefit of priority from Japanese Patent Application No. 2009-90051 filed on Apr. 2, 2009; the entire contents of which are incorporated herein by reference

### BACKGROUND OF THE INVENTION

1. Technical Field

The present invention relates to an optical element in which members, such as prisms and/or glass substrates, are cemented, and its cementing method. The present invention, more particularly, relates to an optical element having an antireflection film on a cementing surface and its cementing method.

2. Description of the Related Art

Optical disks, such as CDs or DVDs, have been wide-spread as media on which various types of digital information can be recorded by light. Wavelengths of light used to write or read data to or from these types of optical disks are different from each other. For example, infrared rays having a wavelength of about 780 nm are used for a CD, and red light having a wavelength of about 650 nm is used for a DVD. As a wavelength of light decreases, an amount of data which can be written in a unit area increases. Therefore, in recent years, optical disks using blue light having a wavelength of 405 nm have been put into practical use.

An optical disk drive is used to read data from an optical disk or write data to the optical disk. The optical disk drive is provided with an optical pickup that emits light to the optical disk and guides light reflected from the optical disk to a photo diode for reading data. Various types of optical disk drives have been known which are used only for one type of optical disk or can deal with plural types of optical disks.

In the optical disk drive capable of dealing with plural types of optical disks, it is necessary to change, for example, the wavelength of light emitted to an optical disk according to the type of the optical disk. However, if dedicated optical pickups are provided so as to correspond to various types of optical disks, its size and/or its manufacturing cost would be increased. Therefore, in the optical disk drive capable of dealing with plural types of optical disks, as many optical elements in the optical pickup may be made common to various types of optical disks as possible.

Polarization is used to read or write data from or to an optical disk. Therefore, the optical pickup includes an optical element that controls a polarized state of light emitted from a light source. For example, the optical pickup includes a wavelength plate that aligns a polarization direction and a polarizing beam splitter (hereinafter, referred to as a “PBS”) that transmits or reflects incident light according to the polarization direction of the incident light. The PBS is a cubic-shaped optical element in which triangular prisms are cemented to each other with a polarizing split film that transmits or reflects incident light according to the polarization direction being interposed therebetween. An adhesive is generally used to cement the prisms.

As such, in the optical element in which base members, such as the prisms, are cemented to each other by an adhesive, a reflectivity of light from the cementing surface is increased due to a difference between a refractive index of the base member or an optical thin film and a refractive index of the adhesive, which results in a reduction in the usage efficiency of light and generation of stray light. JP Hei. 2-27301 A has proposed the structure that one dielectric thin film having a refractive index that is an intermediate value between the refractive index of the base member and the refractive index of the adhesive is provided on the cementing surface and that the dielectric thin film is used as a single-layer antireflection film.

In order to obtain a sufficient antireflection effect with the single-layer antireflection film, it is necessary to set the refractive index of the dielectric thin film to a predetermined appropriate value, in addition to setting the refractive index of the dielectric thin film to an intermediate value between the refractive index of the base member and the refractive index of the adhesive. However, depending on respective materials of the base member and the adhesive and a combination of the base member and the adhesive, there is sometimes no material having an appropriate refractive index, and a sufficient antireflection effect is not obtained with the single-layer antireflection film. JP Hei. 7-225301 A describes an antireflection film in which a difference between the refractive indices of one base member and an adhesive is equal to or less than 0.1 and two dielectric thin films are provided so that the refractive indices thereof increase from the base member side to the adhesive side, in order to more easily reduce the reflectivity of a cementing surface.

However, as described in JP Hei. 2-27301 A, when the single-layer antireflection film is provided on the cementing surface, not only there is no material having an appropriate refractive index depending on a combination of the base member and the adhesive, but also even if a dielectric thin film that functions as an antireflection film in a certain wavelength band (for example, a wavelength band of about 650 nm for a DVD) is provided, it is difficult to obtain a sufficient antireflection effect in other corresponding wavelength bands (for example, wavelength bands for a CD and blue light).

As described in JP Hei. 7-225301 A, when the base member and the adhesive are selected so that the difference between the refractive indices of the base member and the adhesive is equal to or less than 0.1 and when a multi-layer antireflection film is provided on the cementing surface, the antireflection effect is improved as compared to the case where the single-layer antireflection film is provided. However, since the types of materials that can be used to form the base member and the adhesive are limited, it is difficult to select the base member and the adhesive so that the difference between the refractive indices of the base member and the adhesive is equal to or less than 0.1. In addition, merely configuring the antireflection film to include two or more dielectric thin films actually cannot achieve a sufficient antireflection effect in the other corresponding wavelength bands.

The optical pickup uses finite light that is emitted from a light source at an angle of about ±5 degrees with respect to an optical axis. Therefore, the optical elements used in the optical pickup are required to be effectively operated in the entire angular range of the finite light. For example, as described above, the cemented optical element cemented by the adhesive is required to prevent both unnecessary reflection of light that is incident in parallel to the optical axis and reflection of light that is incident at an angle of about ±5 degrees with respect to the optical axis. However, in the antireflection film described in JP Hei. 2-27301 A and JP Hei. 7-225301 A, it is difficult to obtain a sufficient antireflection effect in the entire angular range of the finite light even in a specific wavelength band.

### SUMMARY OF THE INVENTION

The invention has been made in order to solve the above-mentioned problems, and the invention provides a cemented optical element capable of preventing reflection of finite light in plural wavelength bands, and a cementing method.

[1] According to an aspect of the invention, a cemented optical element includes a first transparent base member, a second transparent base member, and a transparent adhesive. The first transparent base member includes an optical thin film on a surface thereof. The optical thin film has a predetermined optical function. The second transparent base member includes an antireflection film on a surface thereof. The antireflection film has a refractive index distribution in which a refractive index gradually decreases from a base side thereof to a surface thereof. The transparent adhesive has a refractive index less than that of the second base member, and cements a surface of the optical thin film and the surface of the antireflection film to integrate the first base member and the second base member.
[2] The maximum refractive index of the antireflection film may be equal to or less than the refractive index of the second base member. The minimum refractive index of the antireflection film may be equal to or more than the refractive index of the adhesive.
[3] The antireflection film may include a plurality of dielectric thin films that are laminated so that the refractive index of the antireflection film decreases in a stepwise manner from the base side of the antireflection film to the surface of the antireflection film.

The refractive index distribution of the antireflection film may extend along a straight line having a gradient of (N₂−N₁)/D, where

N₁ denotes the refractive index of the second base member

N₂ denotes the refractive index of the adhesive, and

D denotes a physical thickness of the antireflection film.

[4] A difference between the refractive index of the antireflection film and the straight line may be equal to or less than 5% of a value on the straight line.
[5] According to another aspect of the invention, a cementing method includes, when a first base member that includes an optical thin film having a predetermined optical function and being formed on a surface thereof and that is made of a transparent material is cemented to a second base member that is made of a transparent material by an adhesive having a refractive index less than that of the second base member so that the optical thin film is interposed between the first base member and the second base member, providing on a surface of the second base member to which the first base member is cemented an antireflection film which has a refractive index distribution in which a refractive index decreases from a second-base-member side to an adhesive side and which prevents reflection of light between the second base member and the adhesive.

With the above configurations and steps, it is possible to provide a cemented optical element capable of preventing reflection of finite light in plural wavelength bands, and a cementing method.

### BRIEF DESCRIPTION OF THE DRAWINGS

FIG. 1 is a diagram illustrating the structure of an optical pickup.

FIG. 2 is a diagram illustrating the structure of a PBS.

FIGS. 3A and 3B are diagrams illustrating the structure of an antireflection film.

FIG. 4 is a graph illustrating an S-polarized light transmissivity of a polarizing split film.

FIGS. 5A and 5B are a diagram and a table illustrating the structure of a PBS according to Comparative Example 1.

FIG. 6 is a graph illustrating the S-polarized light reflectivity Rs at an interface between a second prism and an adhesive, according to Comparative Example 1.

FIG. 7 is a graph illustrating the S-polarized light transmissivity Ts according to Comparative Example 1.

FIGS. 8A and 8B are a diagram and a table illustrating the structure of a PBS according to Comparative Example 2.

FIG. 9 is a graph illustrating the S-polarized light reflectivity Rs at an interface between a second prism and an adhesive, according to Comparative Example 2.

FIG. 10 is a graph illustrating the S-polarized light transmissivity Ts according to Comparative Example 2.

FIG. 11 is a table illustrating the structure of a PBS according to Example.

FIG. 12 is a graph illustrating the S-polarized light reflectivity Rs at an interface between a second prism and an adhesive according to Example.

FIG. 13 is a graph illustrating the S-polarized light transmissivity Ts according to Example.

FIG. 14 is a graph illustrating a method of determining refractive indices and physical thicknesses of dielectric thin films of an antireflection film.

FIGS. 15A and 15B are diagrams illustrating the structure of a deposition apparatus that forms the dielectric thin films.

### DETAILED DESCRIPTION OF EMBODIMENTS OF THE INVENTION

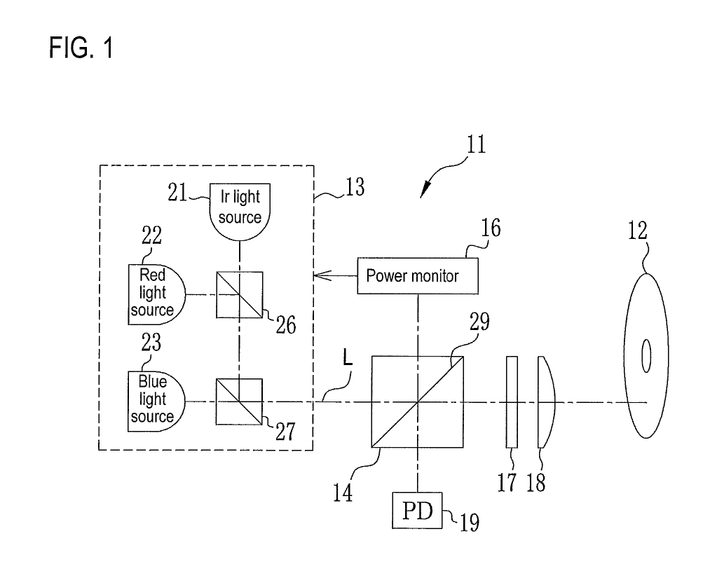

As shown in FIG. 1, an optical pickup 11 includes an optical system that reads data from an optical disk 12 and/or records data on the optical disk 12 and is common to three types of optical disks 12, such as a CD, a DVD, and a blue optical disk. The optical pickup 11 includes, for example, a light source section 13, a PBS 14, a power monitor 16, a quarter-wavelength plate 17, an object lens 18, and a photo diode (PD) 19.

The light source section 13 includes a light source that emits light in three types of wavelength bands corresponding to the three types of optical disks 12 along a common optical axis L. The light source section 13 includes, for example, an infrared light source 21, a red light source 22, a blue light source 23, and dichroic prisms 26 and 27.

The infrared light source 21 includes an infrared laser diode (hereinafter, referred to as an “infrared LD”), a collimator lens, a half-wavelength plate, and a diffraction grating. The infrared LD emits an infrared ray having a wavelength of about 780 nm that is used to read data from a CD. The infrared ray diffused and emitted from the infrared LD is collimated into parallel light by the collimator lens, is incident on the half-wavelength plate, and is S-polarized. Then, the light is incident on the diffraction grating and is then separated into a main beam used to read or write data from or to the CD and two sub-beams used for tracking and/or focusing. Then, the separated light beams are emitted from the diffraction grating. Therefore, the infrared ray emitted from the infrared light source 21 becomes finite light that is emitted at a finite angle of about ±5 degrees. Also, the infrared ray emitted from the infrared light source 21 passes through the dichroic prism 26 and is reflected from the dichroic prism 27 to be incident on the PBS 14.

The red light source 22 includes a red laser diode (hereinafter, referred to as a “red LD”), a collimator lens, a half-wavelength plate, and a diffraction grating. The red LD emits red light having a wavelength of about 650 nm that is used to read data from the DVD. Similarly to the infrared ray emitted from the infrared LD, the red light emitted from the red LD is collimated into parallel light by the collimator lens and is S-polarized by the half-wavelength plate. Then, the light is separated into a main beam and a sub-beam by the diffraction grating. Therefore, the red light emitted from the red light source 22 becomes finite light that is emitted at a finite angle of about ±5 degrees. Also, the red light emitted from the red light source 22 is reflected from the dichroic prisms 26 and 27 and is then incident on the PBS 14.

The blue light source 23 includes a blue laser diode (hereinafter, referred to as a “blue LD”), a collimator lens, a half-wavelength plate, and a diffraction grating. The blue LD emits blue light having a wavelength of about 405 nm that is used to read data from the blue light disk. Similarly to the infrared ray emitted from the infrared LD and the red light emitted from the red LD, the blue light emitted from the red LD is collimated into parallel light by the collimator lens and is S-polarized by the half-wavelength plate. Then, the light is separated into three sub-beams by the diffraction grating. Therefore, the blue light emitted from the blue light source 23 becomes finite light that is emitted at a finite angle of about ±5 degrees. Also, the blue light emitted from the blue light source 23 passes through the dichroic prism 27 and is then incident on the PBS 14.

The PBS 14 is an optical element that transmits or reflects incident light according to a polarized state of the incident light, and is common to light in the three types of wavelength bands, that is, the infrared rays, the red light, and the blue light emitted from the light source section 13. Also, the PBS 14 is provided with a polarizing split film 29 (optical thin film) that is inclined at an angle of 45 degrees with respect to the optical axis. The polarizing split film 29 has a laminated structure of a plurality of dielectric thin films and reflects about 100% of P-polarized incident light. Meanwhile, the polarizing split film 29 transmits about 70% of S-polarized incident light to the optical disk 12, and reflects about 30% of S-polarized incident light to the power monitor 16.

As described above, light in the three types of wavelength bands emitted from the light source section 13 is S-polarized, and the S-polarized light is incident on the PBS 14. Therefore, about 70% of light is transmitted to the optical disk 12, and about 30% of light is incident on the power monitor 16.

The power monitor 16 includes a photo diode that converts incident light into an electric signal, and detects an amount of incident light. Also, the power monitor 16 is connected to the light source section 13. As described above, a predetermined amount of light reflected from the PBS 14 in the light emitted from the light source section 13 is incident on the power monitor 16. Therefore, the amount of light emitted from the light source section 13 is calculated based on the amount of light detected by the power monitor 16. Feedback control is performed for the light sources 21, 22, and 23 of the light source section 13 so that an appropriate amount of light is incident on the optical disk 12.

Meanwhile, in the light emitted from the light source section 13, about 70% of light passing through the PBS 14 is incident on the quarter-wavelength plate 17. The S-polarized light passing through the PBS 14 is converted into a circularly polarized light, that is rotated in a predetermined polarization direction, by the quarter-wavelength plate 17. Then, the circularly polarized light is guided to the optical disk 12 by, for example, a lens or a mirror (not shown) and is focused on the optical disk 12 by the object lens 18.

When data is read from the optical disk 12, as described above, the circularly polarized light focused on the optical disk 12 is reflected from the optical disk 12 while data recorded on the optical data is acquired. The light reflected from the optical disk 12 becomes circularly polarized light that is rotated in the same polarization direction as that when light is incident on the optical disk 12, but travels in the opposite direction. Therefore, when light is incident on the quarter-wavelength plate 17 through the object lens 18 in a direction opposite to the direction in which light is incident on the optical disk 12, the light is P-polarized by the quarter-wavelength plate 17.

Therefore, when the light reflected from the optical disk 12 is incident on the PBS 14, the light is reflected from the polarizing split film 29 and is then incident on the PD 19 that is provided in a position opposite to the power monitor 16. The PD 19 converts the incident light reflected from the optical disk 12 into an electric signal. Also, the PD 19 individually converts three main and sub beams emitted from the light sources 21, 22, and 23 into electric signals. Data recorded on the optical disk 12 is read based on the amount of main beam in the light reflected from the optical disk 12. Also, for example, a lens (not shown) is driven to perform focusing control or tracking control based on the amount of two sub-beams or the diameters of the beams.

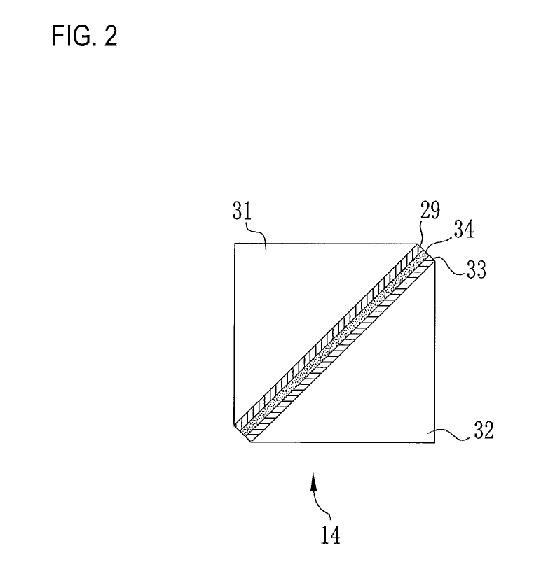

As shown in FIG. 2, the PBS 14 includes a triangular first prism 31 (first base member) and a triangular second prism 32 (second base member) that are cemented to each other with the polarizing split film 29 interposed therebetween. The first prism 31 and the second prism 32 are triangular prisms having the same shape and the same size and are made of a transparent glass material having a high refractive index. Also, the polarizing split film 29 is provided on an inclined plane (a surface cemented to the second prism 32) of the first prism 31, and an antireflection film 33 is provided on an inclined plane of the second prism 32. The first prism 31 and the second prism 32 are cemented to each other by an adhesive 34 having a refractive index lower than those of the prisms 31 and 32. The adhesive 34 cements the polarizing split film 29 on the first prism 31 and the surface of the antireflection film 33 on the second prism 32 to integrate the first prism 31 and the second prism 32. Therefore, a laminated structure is formed in which the second prism 32, the antireflection film 33, the adhesive 34, the polarizing split film 29, and the first prism 31 are arranged in order from the second prism 32 in the cementing surface of the PBS 14. The refractive index of the adhesive 34 is less than those of the first prism 31 and the second prism 32.

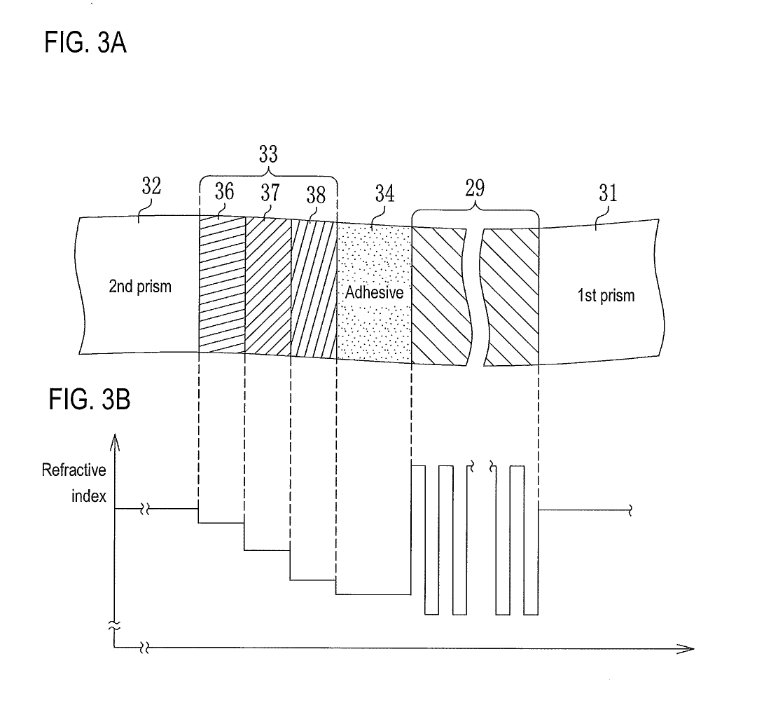

The antireflection film 33 has a laminated structure of a plurality of dielectric thin films and has a refractive index distribution in which the refractive index gradually decreases from the second prism 32, which is an example of the base member, to the adhesive 34. As shown in FIG. 3A, the antireflection film 33 includes three dielectric thin films, that is, a first dielectric thin film 36, a second dielectric thin film 37, and a third dielectric thin film 38, when viewed from the second prism 32. Each of the dielectric thin films 36, 37, and 38 has a physical thickness that is about one third of the overall thickness of the antireflection film 33. Also, the dielectric thin films 36, 37, and 38 are made of the same material. For example, the dielectric thin films 36, 37, and 38 are made of a mixture of three types of dielectric materials, that is, silicon dioxide (SiO₂), niobium pentoxide (Nb₂O₅), and aluminum oxide (Al₂O₃). The mixture ratios of three types of dielectric materials in the dielectric thin films 36, 37, and 38 are different from each other. Therefore, even if the dielectric thin films 36, 37, and 38 are made of the same material, the dielectric thin films 36, 37, and 38 have different refractive indices.

The first dielectric thin film 36 has a refractive index that is less than that of the second prism 32 and is more than that of the adhesive 34. Also, the three types of dielectric materials forming the first dielectric thin film 36 are mixed so that the first dielectric thin film 36 has the highest refractive index among the dielectric thin films 36, 37, and 38.

Similarly to the first dielectric thin film 36, the second dielectric thin film 37 has a refractive index that is less than that of the second prism 32 and is more than that of the adhesive 34. Also, the three types of dielectric materials forming the second dielectric thin film 37 are mixed so that the refractive index of the second dielectric thin film 37 is less than that of the first dielectric thin film 36 and is more than that of the third dielectric thin film 38.

Similarly to the first and second dielectric thin films 36 and 37, the third dielectric thin film 38 has a refractive index that is less than that of the second prism 32 and is more than that of the adhesive 34. Also, the three types of dielectric materials forming the third dielectric thin film 38 are mixed so that the third dielectric thin film 38 has the lowest refractive index among the dielectric thin films 36, 37, and 38.

Therefore, as shown in FIG. 3B, the antireflection film 33 has a refractive index distribution in which the refractive index gradually decreases in a stepwise manner from the second prism 32 to the adhesive 34. The maximum refractive index of the antireflection film 33 is less than the refractive index of the second prism 32, and the minimum refractive index thereof is more than the refractive index of the adhesive 34.

As described above, in the PBS 14, the antireflection film 33 having the refractive index distribution in which the refractive index gradually decreases in the stepwise manner from the second prism 32 to the adhesive 34 is provided between the second prism 32 and the adhesive 43. In this way, the PBS 14 is effectively operated in a plurality of wavelength bands, such as infrared rays, red light, and blue light. As such, although finite light in a predetermined angular range is incident on the PBS 14, the antireflection film 33 can prevent the finite light from being reflected between the second prism 32 and the adhesive 34.

Next, an example of the PBS 14 having the above-mentioned structure will be described with reference to detailed data of the first and second prisms 31 and 32, the polarizing split film 29, the antireflection film 33, and the adhesive 34 of the PBS 14. First, an example of the structure of the polarizing split film 29 that is common to Example and Comparative Examples 1 and 2, which will be described below, will be described. Then, for comparison with Example, a PBS according to Comparative Example 1 in which the antireflection film 33 is not provided and a PBS according to Comparative Example 2 in which a single-layer dielectric thin film is provided instead of the antireflection film 33 will be described. Also, as an example of the PBS 14, a PBS according to Example in which the antireflection film 33 is provided will be described.

### [Polarizing Split Film]

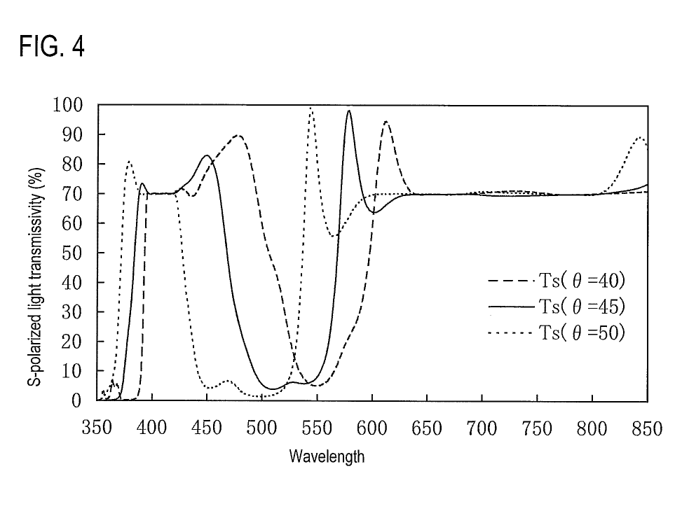

For example, the polarizing split film 29 is formed by overlapping three types of dielectric thin films made of silicon dioxide (SiO₂), niobium pentoxide (Nb₂O₅), and aluminum oxide (Al₂O₃) plural times. The detailed structure of the polarizing split film 29, such as the order in which the dielectric thin films are laminated, the number of layers laminated, and the thickness of each of the dielectric thin films, is determined in consideration of the second prism 32 and the adhesive 34 so that the polarizing split film transmits about 70% of S-polarized light and reflects about 30% of S-polarized light when the incident angle θ of light on the polarizing split film 29 is 45 degrees in three types of wavelengths, such as infrared rays (about 780 nm), red light (about 650 nm), and blue light (about 405 nm) as represented by a solid line in FIG. 4. At the same time, the structure of the dielectric thin films of the polarizing split film 29 is determined so that the polarizing split film 29 reflects about 100% of P-polarized light.

In addition, light is incident on the polarizing split film 29 at an incident angle θ of 45±5 degrees. The polarizing split film 29 is designed in consideration of the range of the incident angle θ. Therefore, as represented by a dashed line and a dotted line in FIG. 4, when the incident angle θ decreases, a graph of the S-polarized light transmissivity Ts is entirely shifted to a long wavelength side, and when the incident angle θ increases, the graph of the S-polarized light transmissivity Ts is entirely shifted to a short wavelength side. The structure of the polarizing split film is designed so that the S-polarized light transmissivity Ts is maintained at about 70% in the wavelength bands of at least infrared rays, red light, and blue light used by the optical pickup 11 even if the incident angle θ is changed in the range of 45±5 degrees, similarly to the case where the incident angle θ is 45±0 degrees. Similarly, the structure of the polarizing split film is designed so that the P-polarized light reflectivity is maintained at about 100% in the wavelength bands of at least infrared rays, red light, and blue light used by the optical pickup 11 even if the incident angle θ is changed in the range of 45±5 degrees, similarly to the case where the incident angle θ is 45±0 degrees.

### Comparative Example 1

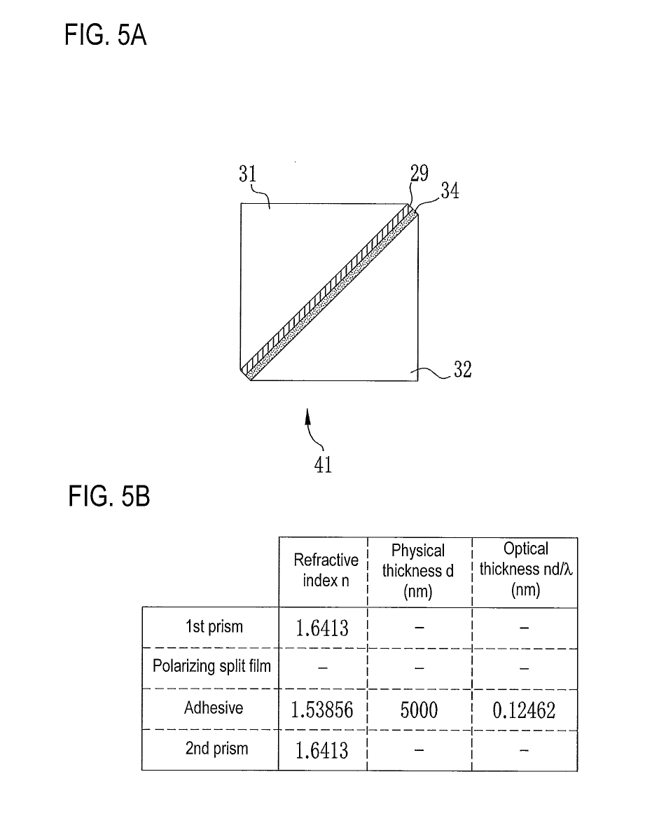

For comparison with Example, which will be described below, as shown in FIG. 5A, an example of a PBS 41 in which the antireflection film 33 is not provided and the first prism 31 and the second prism 32 are cemented to each other by the adhesive 34 with only the polarizing split film 29 interposed therebetween will be described. The first prism 31, the polarizing split film 29, the adhesive 34, and the second prism 32 are arranged in this order in the cementing surface of the PBS 41. The refractive index, the physical thickness d (nm), and the optical thickness nd/λ (nm) of each element of the PBS 41 are as shown in FIG. 5B. The polarizing split film 29 used in the PBS 41 has the above-mentioned structure and does not affect the structure of the antireflection film 33. Therefore, a detailed description thereof will be omitted.

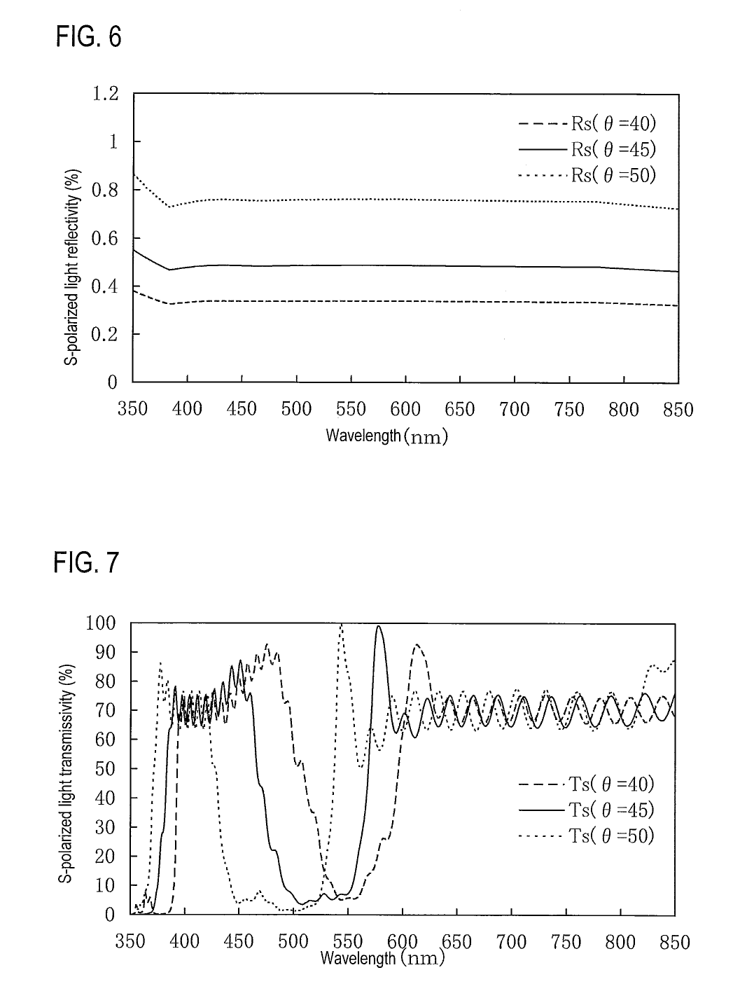

In the PBS 41 in which the antireflection film 33 is not provided, as shown in FIG. 6, when the incident angle θ is 45 degrees, the S-polarized light reflectivity Rs at the interface between the second prism 32 and the adhesive 34 is about 0.5%, regardless of the wavelength of light. Also, when the incident angle θ is 40 degrees, the S-polarized light reflectivity Rs at the interface between the second prism 32 and the adhesive 34 of the PBS 41 is about 0.35%, which is a small value, regardless of the wavelength of light. When the incident angle θ is 50 degrees, the reflectivity Rs is about 0.75%. As such, the S-polarized light reflectivity Rs at the interface between the second prism 32 and the adhesive 34 of the PBS 41 varies a little depending on the incident angle θ. The reflectivity decreases to a value that is less than 1% of the amount of incident light in the actual range of the incident angle of the finite light used by the optical pickup 11. Therefore, it is expected that the optical function of the polarizing split film 29 of the PBS 41 will be substantially equal to the designed optical function.

However, as represented by a solid line in FIG. 7, when the S-polarized light is incident on the PBS 41 at an angle θ of 45 degrees and the S-polarized light transmissivity Ts is measured, a large periodical variation (a so-called ripple) in the transmissivity occurs in the wavelength band in which it is expected that the transmissivity will be substantially constant (see FIG. 4: a wavelength of 400 to 430 nm and 630 to 800 nm). Also, as represented by a dashed line in FIG. 7, if the S-polarized light is incident on the PBS 41 at an angle θ of 40 degrees and the S-polarized light transmissivity Ts is measured, the ripple is shifted to a long wavelength side. Similarly, as represented by a dotted line in FIG. 7, if the S-polarized light is incident on the PBS 41 at an angle θ of 50 degrees and the S-polarized light transmissivity Ts is measured, the ripple is shifted to a short wavelength side. Therefore, in a specific wavelength band, the transmissivity Ts varies greatly depending on the incident angle θ. For example, in the range of the incident angle θ of 45±5 degrees, the S-polarized light transmissivity Ts having a wavelength of 405 nm varies more than 2%, the S-polarized light transmissivity Ts having a wavelength of 650 nm varies more than 3%, and the S-polarized light transmissivity Ts having a wavelength of 780 nm varies more than 8%.

As such, as can be seen from FIG. 7, even if the same polarizing split film 29 is used, the amplitude of the ripple that has a great influence on the optical function of the PBS 41 is increased when there is a large difference between the refractive indices of the second prism 32 and the adhesive 34, and the period of the ripple varies depending on the thickness of the adhesive 34. Therefore, the ripple is caused by slight reflection of light from the interface between the second prism 32 and the adhesive 34.

### Comparative Example 2

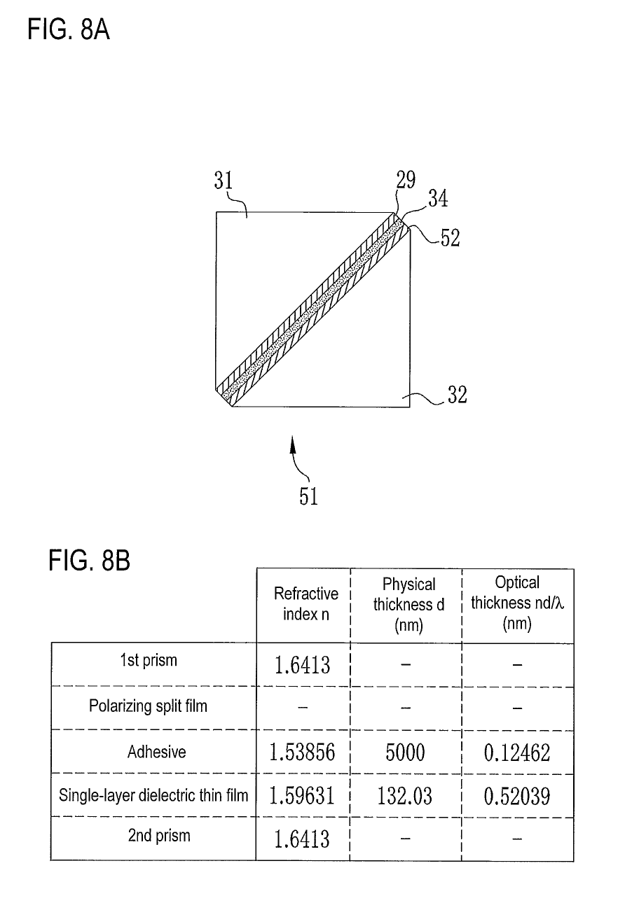

As described above, in the PBS 41 in which the antireflection film 33 is not provided, the ripple occurs and changes depending on a difference between the refractive indices of the second prism 32 and the adhesive 34. Therefore, here, an example of a PBS in which a single-layer dielectric thin film is provided between the second prism 32 and the adhesive 34 to reduce the difference between the refractive indices of the second prism 32 and the adhesive 34 will be described. As shown in FIG. 8A, a PBS 51 includes a single dielectric thin film 52 (hereinafter, referred to as a “single-layer dielectric thin film 52”) as an antireflection film, instead of the antireflection film 33 including plural dielectric thin films. The second prism 32, the single-layer dielectric thin film 52, the adhesive 34, the polarizing split film 29, and the first prism 31 are arranged in this order in the cementing surface of the PBS 51.

As shown in FIG. 8B, the first and second prisms 31 and 32, the adhesive 34, and the polarizing split film 29 of the PBS 51 are the same as those in Comparative Example 1. The single-layer dielectric thin film 52 is made of a mixture of three types of dielectric materials, that is, SiO₂, Nb₂O₅, and Al₂O₃, so that the refractive index n thereof is an intermediate value between the refractive index (n=1.6413) of the second prism 32 and the refractive index (n=1.53856) of the adhesive 34, in order to reduce the difference between the refractive indices of the second prism 32 and the adhesive 34. In the PBS 51, the refractive index n of the single-layer dielectric thin film 52 is 1.59631. Also, the physical thickness d of the single-layer dielectric thin film 52 is 132.03 nm.

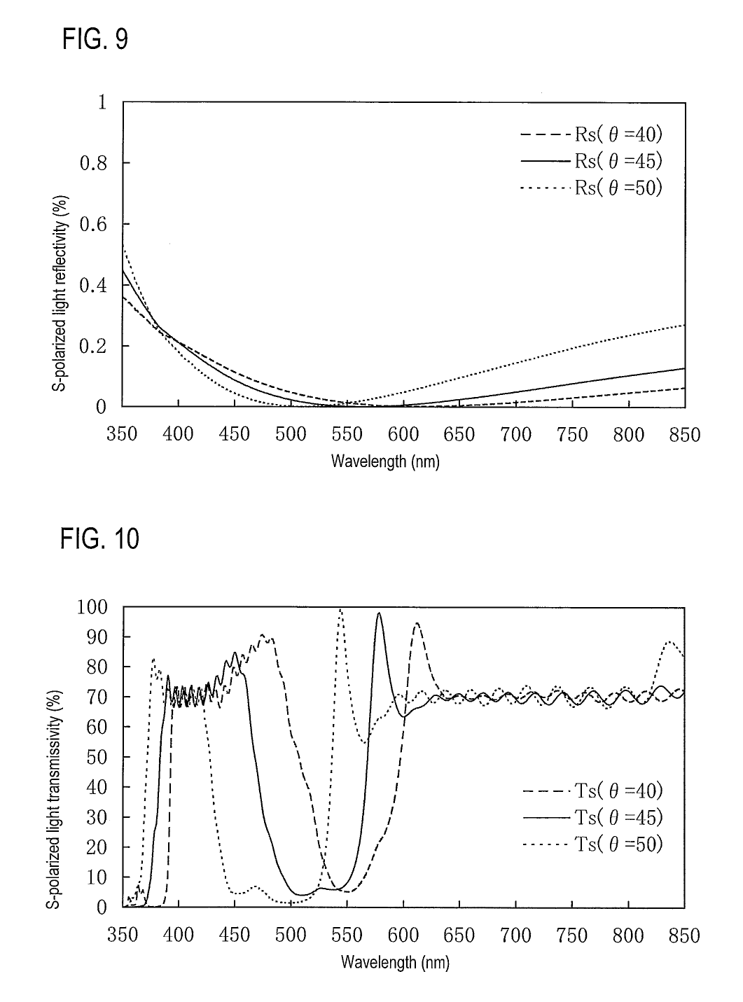

In the PBS 51 in which the single-layer dielectric thin film 52 is provided between the second prism 32 and the adhesive 34, as represented by a solid line in FIG. 9, when the incident angle θ is 45 degrees, the S-polarized light reflectivity Rs at the interface between the second prism 32 and the adhesive 34 is equal to or less than 0.3% in the substantially entire wavelength band. Therefore, in the PBS 51 including the single-layer dielectric thin film 52, the S-polarized light reflectivity Rs at the interface between the second prism 32 and the adhesive 34 is equal to or less than half of that in the PBS 41 (see FIG. 6) in which the second prism 32 comes into direct contact with the adhesive 34. Also, as represented by a dashed line and a dotted line in FIG. 9, the S-polarized light reflectivity Rs at the interface between the second prism 32 and the adhesive 34 of the PBS 51 varies with a change of the incident angle θ. A variation ratio of the reflectivity Rs when the incident angle θ of 45 degrees is set as a reference angle is about 0.14% at most, which is less than that of the reflectivity Rs (see FIG. 6) at the interface between the second prism 32 and the adhesive 34 of the PBS 41.

Therefore, it is expected that the ripple occurring in the PBS 41 according to Comparative Example 1 will not occur. However, as represented by a solid line in FIG. 10, when the S-polarized light is incident on the PBS 51 at an angle θ of 45 degrees and the S-polarized light transmissivity Ts is measured, a remakable ripple occurs similarly to Comparative Example 1 even though the amplitude of the ripple is reduced as compared to the PBS 41 (see FIG. 7) according to Comparative Example 1. Also, the cycle of the ripple occurring in the PBS 51 is substantially equal to that in the PBS 41 according to Comparative Example 1.

As such, in the PBS 51, providing the single-layer dielectric thin film 52 makes it possible to reduce the amplitude of the ripple, but a remarkable ripple still occurs. Therefore, as represented by a dashed line and a dotted line in FIG. 10, the ripple is shifted with a variation in the incident angle θ, and in a specific wavelength band, the transmissivity Ts varies largely depending on the incident angle θ. For example, at an incident angle θ of 45±5 degrees, the S-polarized light transmissivity Ts having a wavelength of 405 nm varies more than 3.5%, the S-polarized light transmissivity Ts having a wavelength of 650 nm varies more than 3.1%, and the S-polarized light transmissivity Ts with a wavelength of 780 nm varies more than 2.9%. In Comparative Example 2, the single-layer dielectric thin film 52 is made of SiO₂, Nb₂O₅, and Al₂O₃, the refractive index n is 1.59631, and the physical thickness d is 132.03 nm. However, the single-layer dielectric thin film 52 may be made of other dielectric materials, or the refractive index n or the physical thickness d may be changed. In this case, the amplitude of the ripple is reduced as compared to the PBS 41 according to Comparative Example 1, but the ripple cannot be suppressed more than that in the PBS 51.

### Examples

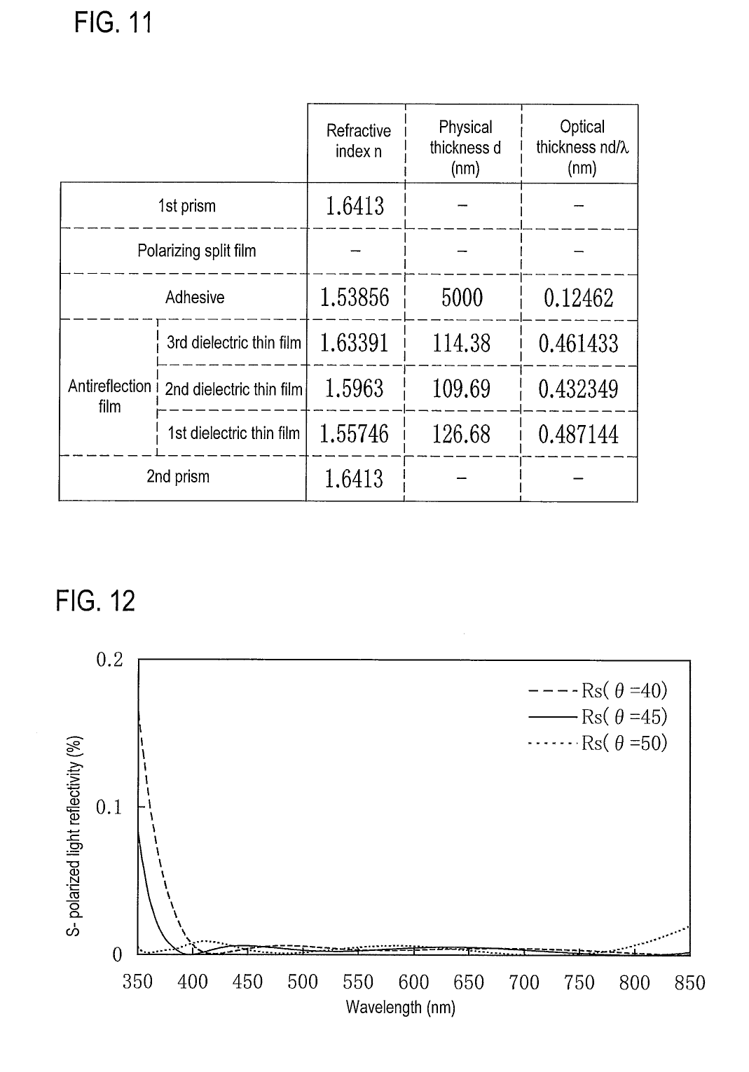

As described above, in the PBS 41 according to Comparative Example 1 or the PBS 51 according to Comparative Example 2, when the incident angle θ is changed by only about 5 degrees, the S-polarized light transmissivity Ts varies greatly due to the ripple. Therefore, in PBS 14, the antireflection film 33 is provided between the second prism 32 and the adhesive 34 to further reduce the ripple. Also, data of each element of the PBS 14 is shown in FIG. 11, and the first and second prisms 31 and 32, the polarizing split film 29, and the adhesive 34 are the same as those in Comparative Examples 1 and 2. The first dielectric thin film 36, the second dielectric thin film 37, and the third dielectric thin film 38 of the antireflection film 33 are made of a mixture of SiO₂, Nb₂O₅, and Al₂O₃ so that the refractive indices thereof decrease in a stepwise manner from the second prism 32 according to the refractive indices of the second prism 32 and the adhesive 34.

In the PBS 14 including the antireflection film 33, as represented by a solid line in FIG. 12, the S-polarized light reflectivity Rs at the interface between the second prism 32 and the adhesive 34 with an incident angle θ of 45 degrees is about 0% in the entire wavelength band, which is less than those in Comparative Example 1 (see FIG. 6) and Comparative Example 2 (see FIG. 9). As represented by a dotted line in FIG. 12, when the incident angle θ is changed, the S-polarized light reflectivity Rs is also changed. However, the reflectivity Rs is about 0% in the range of the incident angle θ of 45±5 degrees.

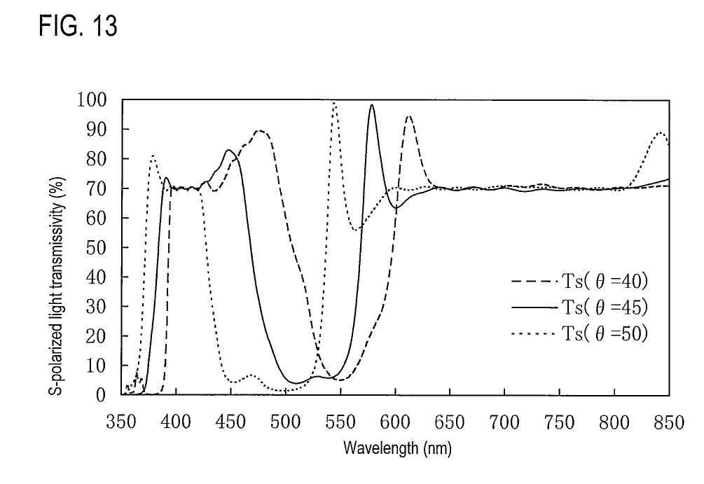

As such, in the PBS 14 including the antireflection film 33, reflection of the S-polarized light and transmission of the P-polarized light at and through the interface between the second prism 32 and the adhesive 34 are controlled. Therefore, as represented by a solid line in FIG. 13, when S-polarized light is incident on the PBS 14 at an incident angle θ of 45 degrees, less ripple occurs, and the transmissivity Ts that is substantially equal to the design value (see FIG. 4) of the polarizing split film 29 is obtained. Also, as represented by a dashed line and a dotted line in FIG. 13, even if the incident angle θ of S-polarized light on the PBS 14 is changed in the range of 45±5 degrees, the transmissivity Ts is maintained at a substantially constant value in plural the wavelength bands including a wavelength band of about 780 nm for a CD, a wavelength band of about 650 nm for a DVD, and a wavelength band of about 405 nm for a blue optical disk.

As can be seen from Example and Comparative Examples 1 and 2, in the PBSs 41 and 51 according to Comparative Examples 1 and 2, even if the polarizing split film 29 is formed so as to be effectively operated in a plurality of wavelength bands, the polarizing split film is greatly affected by the ripple, and an expected optical function is not obtained. Therefore, the polarizing split films 41 and 51 are not suitable for the optical pickup 11 in a plurality of wavelength bands. However, as in the PBS 14 according to Example, if the antireflection film 33 is provided between the second prism 32 and the adhesive 34, the antireflection film 29 having an optical function that is substantially the same as the designed optical function can be achieved, and it is possible to use the PBS in a plurality of wavelength bands.

In the above-mentioned Example, the S-polarized light transmissivity is described as an example. However, the P-polarized light reflectivity can be described in a similar manner. If ripple occurs in the P-polarized light reflectivity in the case where the second prism 32 comes into direct contact with the adhesive 34 without the antireflection film 33 interposed therebetween, or where the second prism 32 and the adhesive 34 are cemented to each other with a single-layer dielectric thin film interposed therebetween, it is possible to reduce the ripple by interposing the antireflection film 33 between the second prism 32 and the adhesive 34.

In the above-mentioned embodiment and Example, the antireflection film 33 includes three dielectric thin films, that is, the first dielectric thin film 36, the second dielectric thin film 37, and the third dielectric thin film 38. However, the number of dielectric thin films of the antireflection film 33 is not limited thereto. That is, the antireflection film 33 may be formed so that the refractive index thereof gradually decreases from the second prism 32, which is the base member, to the adhesive 34, which is on the surface side. For example, the number of dielectric thin films of the antireflection film 33 may be two which is smaller than that in the above-mentioned embodiment and Example, or it may be four or more which is more than that in the above-mentioned embodiment and Example.

When the antireflection film 33 includes a small number of dielectric thin films, the ripple is more likely to occur than the case where the antireflection film 33 includes a large number of dielectric thin films. Also, in order to sufficiently reduce the ripple, it is necessary to more accurately determine the refractive indices of the dielectric thin films. When the antireflection film 33 includes a large number of dielectric thin films, it is possible to reduce the ripple more easily than the case where the antireflection film 33 includes a small number of dielectric thin films, but the time and cost required to manufacture the antireflection film 33 would be increased. When the antireflection film 33 includes two to ten dielectric thin films, less ripple occurs. However, even though the antireflection film 33 includes eleven or more dielectric thin films, the effect of reducing the ripple would not be improved any further. Therefore, the number of dielectric thin films of the antireflection film 33 is preferably equal to or more than two and equal to or less than ten, and more preferably, equal to or more than two and equal to or less than five. In particular, it is preferable that the antireflection film 33 include three dielectric thin films as in the above-mentioned embodiment and Example, in order to reduce both the time and cost required to manufacture the antireflection film 33 and the ripple.

In the above-mentioned embodiment and Example, an example of the refractive indices of the dielectric thin films 36, 37, and 38 of the antireflection film 33 is described, but the refractive indices of the dielectric thin films 36, 37, and 38 are not limited thereto.

As in Comparative Example 1, when the second prism 32 and the adhesive 34 are directly cemented to each other, the amplitude of the ripple occurring in the S-polarized light transmissivity Ts depends on the difference between the refractive indices of the second prism 32 and the adhesive 34. This tendency is the same as that in the case where the antireflection film 33 is provided. Therefore, it is preferable that the antireflection film 33 be provided so that the refractive index thereof decreases from the second prism 32 to the adhesive 34 and the difference between the refractive indices of the antireflection film 33 and the second prism 32 be small. Also, it is preferable that the difference between the refractive indices of the antireflection film 33 and the adhesive 34 be small. It is also preferable to minimize the difference between the refractive indices of the dielectric thin films of the antireflection film 33.

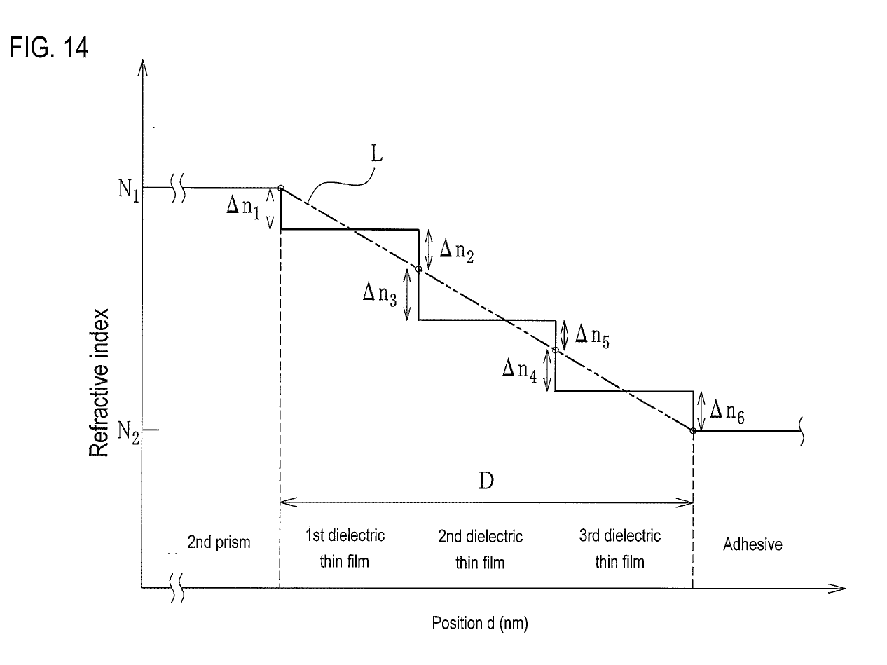

Therefore, as shown in FIG. 14, in a graph of the refractive index of the interface between the second prism 32 and the antireflection film 33 in a position d in the thickness direction in which the refractive index of the second prism 32 is N₁, the refractive index of the adhesive 34 is N₂, and the physical thickness of the antireflection film 33 is D, it is most preferable that the refractive index of the antireflection film 33 be changed along a straight line L that connects the end of the second prism 32 close to the antireflection film 33 and the end of the adhesive 34 close to the antireflection film 33 and has a gradient (N₂−N₁)/D.

Considering restrictions in the actual manufacturing process, such as the time or cost required to manufacture the antireflection film 33 and yield, it is difficult to form the antireflection film 33 so that the antireflection film 33 includes about several to several tens of dielectric thin films and the refractive index varies along the straight line L as the number of dielectric thin films of the antireflection film 33 is reduced. In this case, it is preferable that the refractive index and the physical thickness of each dielectric thin film be determined so that a refractive index difference from a value on the straight line L is equal to or less than 5% of a value on the straight line L, more preferably, equal to or less than 3% of the value on the straight line L, and most preferably, equal to or less than 2% of the value on the straight line L. When the refractive index difference from a value on the straight line L is more than 5%, the ripple becomes remarkable due to the reflection of light at the interface between the second prism and the antireflection film 33. As a result, it is difficult to obtain a good optical function in a plurality of wavelength bands, unlike the above-mentioned embodiment and Example.

For example, as shown in FIG. 14, when the antireflection film 33 includes three dielectric thin films, that is, the first dielectric thin film 36, the second dielectric thin film 37, and the third dielectric thin film 38, it is preferable that the refractive index and the physical thickness of each of the dielectric thin films 36, 37, and 38 be determined such that Δn₁ to Δn₆ are all equal to or less than 5% of the value on the straight line L. Here, Δn₁ indicates the difference between a value on the straight line L on the interface between the second prism 32 and the first dielectric thin film 36 and the refractive index of the first dielectric thin film 36. Similarly, Δn₂ and Δn₃ indicate the difference between a value on the straight line L on the interface between the first dielectric thin film 36 and the second dielectric thin film 37 and the refractive index of the first dielectric thin film 36 and the difference between a value on the straight line L on the interface between the first dielectric thin film 36 and the second dielectric thin film 37 and the refractive index of the second dielectric thin film 37, respectively, and Δn₄ and Δn₅ indicate the difference between a value on the straight line L on the interface between the second dielectric thin film 37 and the third dielectric thin film 38 and the refractive index of the second dielectric thin film 37 and the difference between a value on the straight line L on the interface between the second dielectric thin film 37 and the third dielectric thin film 38 and the refractive index of the third dielectric thin film 38, respectively. In addition, Δn₆ indicates the difference between a value on the straight line L on the interface between the third dielectric thin film 38 and the adhesive 34 and the refractive index of the third dielectric thin film 38.

In the above-mentioned embodiment and Example, the maximum refractive index of the antireflection film 33 is less than the refractive index of the second prism 32, and the minimum refractive index thereof is more than the refractive index of the adhesive 34. However, the refractive index distribution of the antireflection film 33 is not limited thereto. For example, when the antireflection film 33 has a refractive index distribution in which the refractive index gradually decreases from the second prism 32 to the adhesive 34, the antireflection film 33 may be formed such that the refractive index of a portion close to the second prism 32 is equal to that of the second prism 32 or the refractive index of a portion close to the adhesive 34 is equal to that of the adhesive 34. In addition, for example, the antireflection film 33 may be formed such that the refractive index of a portion close to the second prism 32 is more than that of the second prism 32 or the refractive index of a portion close to the adhesive 34 is less than that of the adhesive 34. However, in order to form the antireflection film with a small number of dielectric thin films to obtain a sufficient antireflection effect, as in the above-mentioned embodiment and Example, the antireflection film 33 may be formed such that the maximum refractive index thereof is equal to or less than the refractive index of the second prism 32 and the minimum refractive index thereof is equal to or less than the refractive index of the adhesive 34.

In the above-mentioned embodiment and Example, the dielectric thin films 36, 37, and 38 of the antireflection film 33 are sequentially arranged in stages from the second prism 32 in decreasing order of the refractive indices. However, the structure of the antireflection film 33 is not limited thereto. For example, when the antireflection film 33 includes a plurality of dielectric thin films, the dielectric thin films may be arranged such that the refractive index of a dielectric thin film interposed between dielectric thin films provided at both sides thereof is more (less) than those of the dielectric thin films provided at both sides and the order of the refractive index distribution of a portion may be reversed, within the range in which the ripple does not occur, as described above. However, in this case, in order to obtain a sufficient effect, the antireflection film 33 needs to have a refractive index distribution in which the refractive index gradually decreases from the second prism 32 to the adhesive 34, as in the above-mentioned embodiment and Example.

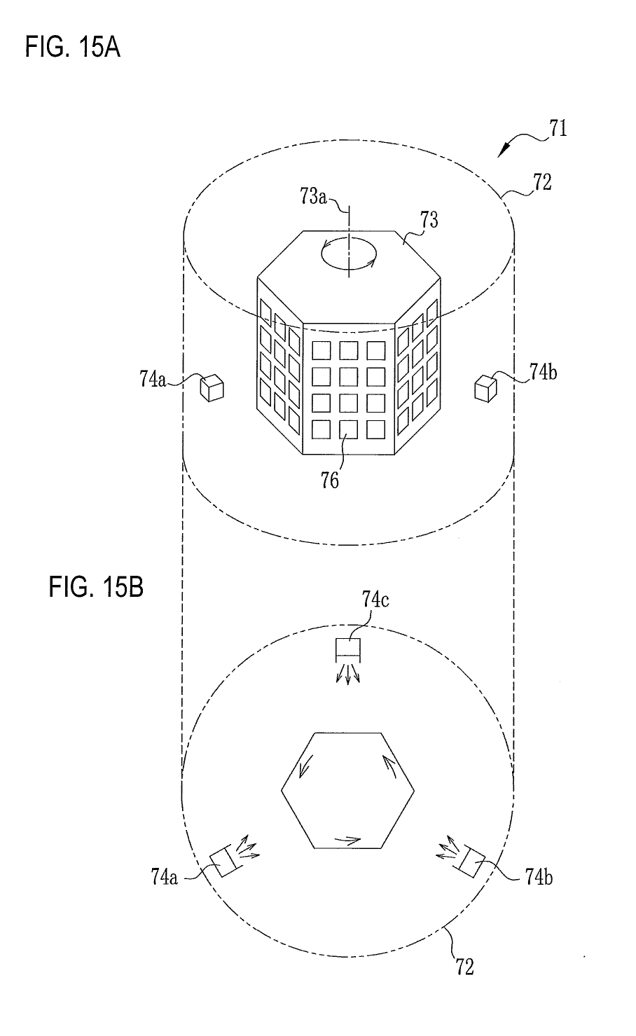

In the above-mentioned embodiment and Example, each of the dielectric thin films 36, 37, and 38 of the antireflection film 33 is made of a mixture of SiO₂, Nb₂O₅, and Al₂O₃. The dielectric thin films that are made of a plurality of dielectric materials and have different refractive indices may be manufactured by, for example, a deposition apparatus 71 shown in FIG. 15.

As shown in FIGS. 15A and 15B, the deposition apparatus 71 includes a vacuum chamber 72, a rotating drum 73, and deposition sources 74a to 74c. The rotating drum 73 has, for example, a hexagonal prism shape and is provided so as to be rotatable about a central axis 73a. A plurality of substrate holders 76 is provided on each of six side surfaces of the rotating drum 72. The deposition sources 74a to 74c are filled with SiO₂, Nb₂O₅, and Al₂O₃, respectively, and the deposition sources 74a to 74c uniformly scatter the dielectric materials to the side surfaces of the rotating drum 72. In addition, shutter mechanisms (not shown) are provided in the deposition sources 74a to 74c, such that it is possible to arbitrarily change the timing when the dielectric materials are scattered and the amount of dielectric materials scattered.

When the deposition apparatus 71 having the above-mentioned structure is used to manufacture the antireflection film 33, the second prism 32 is set to the substrate holder 76 with an inclined plane facing the outside of the rotating drum 73. The rotating drum 73 is rotated while adjusting the amount of dielectric materials scattered from the deposition sources 74a to 74c such that the dielectric materials are mixed into the first dielectric thin film 36. The dielectric materials are scattered from the deposition sources 74a to 74c for a predetermined amount of time.

Then, a dielectric thin film made of a mixture of SiO₂, Nb₂O₅, and Al₂O₃ is formed on the second prism 32 according to the relative ratio of the dielectric materials scattered from the deposition sources 74a to 74c. The physical thickness of the formed dielectric thin film is determined by the time when the dielectric materials are scattered from the deposition sources 74a to 74c and the amount of dielectric materials scattered. Here, the time when the dielectric materials are scattered and the amount of dielectric materials scattered are adjusted according to the physical thickness of the first dielectric thin film 36. Therefore, the formed dielectric thin film becomes the first dielectric thin film 36. The second dielectric thin film 37 and the third dielectric thin film 38 are sequentially formed by the same method as that used to form the first dielectric thin film 36. In this way, the antireflection film 33 is formed. In the deposition apparatus 71, it is possible to effectively form the antireflection film 33 by adjusting the amount of dielectric materials scattered from the deposition sources 74a to 74c, while maintaining the vacuum chamber 72 to be vacuum.

In the above-mentioned embodiment and Example, the polarizing split film 29 and the antireflection film 33 are made of SiO₂, Nb₂O₅, and Al₂O₃, but the material forming the polarizing split film 29 or the antireflection film 33 is not limited to the dielectric material. Other known dielectric materials may be used. In addition, the polarizing split film 29 or the antireflection film 33 is not necessarily made of a combination of three types of dielectric materials, but it may be made of two kinds of dielectric materials or four or more kinds of dielectric materials.

In the above-mentioned embodiment and Example, both the polarizing split film 29 and the antireflection film 33 are made of SiO₂, Nb₂O₅, and Al₂O₃, but the number or the kind of dielectric materials forming the polarizing split film 29 and the antireflection film 33 may be changed. However, in the above-mentioned embodiment and Example, the polarizing split film 29 and the antireflection film 33 may be made of the same dielectric material and the polarizing split film 29 and the antireflection film 33 may be manufactured by the same deposition apparatus. In this case, it is possible to easily manufacture the polarizing split film 29 and the antireflection film 33 at a low cost.

In the above-mentioned Example, the detailed example of the first and second prisms 31 and 32 and the adhesive 34 is described. However, the first and second prisms 31 and 32 and the adhesive 34 may be made of any materials other than the materials in the above-mentioned Example. It is preferable to select materials forming the second prism 32 and the adhesive 34 such that the difference between the refractive indices of the second prism 32 and the adhesive 34 is reduced.

In the above-mentioned embodiment and Example, the antireflection film 33 includes a plurality of dielectric thin films and is formed such that the refractive index thereof is reduced in stages from the second prism 32 to the adhesive 34, but the invention is not limited thereto. The antireflection film 33 may have a refractive index distribution in which the refractive index thereof is smoothly reduced from the second prism 32 to the adhesive 34. For example, when the deposition apparatus 71 is used to form the antireflection film 33, the ratio of the dielectric materials scattered from the deposition sources 74a to 74c is gradually and smoothly changed. The antireflection film manufactured in this way is one dielectric thin film without a clear boundary therein and is an antireflection film having a refractive index that is reduced from the second prism 32 to the adhesive 34 along the straight line L. Therefore, the one antireflection film manufactured in this way may be used as the antireflection film 33.

In the above-mentioned embodiment and Example, the PBS used in the optical pickup 11 is given as an example, but the invention is not limited thereto. The invention can be appropriately applied to any cemented optical elements other than the PBS for the optical pickup 11 as long as a glass substrate is cemented to a base, such as a lens or a prism, with an optical thin film interposed therebetween. In addition, the kind of optical thin film interposed between the bases is not limited to the polarizing split film 29, and the shape of the optical thin film is not limited to the shape of the PBS. Therefore, for example, the invention can be applied to known cemented optical elements, such as a cemented lens, a flat filter for image capture, a PBS including a polarizing split film that is made of a material with a property different from that forming the polarizing split film 29, and a dichroic prism, other than the PBS for the optical pickup 11.

What is claimed is:

1. A cemented optical element comprising:
a first transparent base member that includes an optical thin film on a surface thereof, the optical thin film having a predetermined optical function;
a second transparent base member that includes an antireflection film on a surface thereof, the antireflection film having a refractive index distribution in which a refractive index gradually decreases from a base side thereof to a surface thereof; and
a transparent adhesive that has a refractive index less than that of the second base member, and cements a surface of the optical thin film and the surface of the antireflection film to integrate the first base member and the second base member.

2. The cemented optical element according to claim 1, wherein
the maximum refractive index of the antireflection film is equal to or less than the refractive index of the second base member, and
the minimum refractive index of the antireflection film is equal to or more than the refractive index of the adhesive.

3. The cemented optical element according to claim 1, wherein the antireflection film includes a plurality of dielectric thin films that are laminated so that the refractive index of the antireflection film decreases in a stepwise manner from the base side of the antireflection film to the surface of the antireflection film.

4. The cemented optical element according to claim 2, wherein the antireflection film includes a plurality of dielectric thin films that are laminated so that the refractive index of the antireflection film decreases in a stepwise manner from the base side of the antireflection film to the surface of the antireflection film.

5. The cemented optical element according to claim 1, wherein
the refractive index distribution of the antireflection film extends along a straight line having a gradient of (N₂−N₁)/D, where
N₁ denotes the refractive index of the second base member
N₂ denotes the refractive index of the adhesive, and
D denotes a physical thickness of the antireflection film.

6. The cemented optical element according to claim 2, wherein
the refractive index distribution of the antireflection film extends along a straight line having a gradient of (N₂−N₁)/D, where
N₁ denotes the refractive index of the second base member
N₂ denotes the refractive index of the adhesive, and
D denotes a physical thickness of the antireflection film.

7. The cemented optical element according to claim 3, wherein
the refractive index distribution of the antireflection film extends along a straight line having a gradient of (N₂−N₁)/D, where
N₁ denotes the refractive index of the second base member
N₂ denotes the refractive index of the adhesive, and
D denotes a physical thickness of the antireflection film.

8. The cemented optical element according to claim 4, wherein
the refractive index distribution of the antireflection film extends along a straight line having a gradient of (N₂−N₁)/D, where
N₁ denotes the refractive index of the second base member
N₂ denotes the refractive index of the adhesive, and
D denotes a physical thickness of the antireflection film.

9. The cemented optical element according to claim 5, wherein a difference between the refractive index of the antireflection film and the straight line is equal to or less than 5% of a value on the straight line.

10. The cemented optical element according to claim 6, wherein a difference between the refractive index of the antireflection film and the straight line is equal to or less than 5% of a value on the straight line.

11. The cemented optical element according to claim 7, wherein a difference between the refractive index of the antireflection film and the straight line is equal to or less than 5% of a value on the straight line.

12. The cemented optical element according to claim 8, wherein a difference between the refractive index of the antireflection film and the straight line is equal to or less than 5% of a value on the straight line.

13. A cementing method comprising:
when a first base member that includes an optical thin film having a predetermined optical function and being formed on a surface thereof and that is made of a transparent material is cemented to a second base member that is made of a transparent material by an adhesive having a refractive index less than that of the second base member so that the optical thin film is interposed between the first base member and the second base member, providing on a surface of the second base member to which the first base member is cemented an antireflection film which has a refractive index distribution in which a refractive index decreases from a second-base-member side to an adhesive side and which prevents reflection of light between the second base member and the adhesive.
